(19) United States
(12) Patent Application Publication
(10) Pub. No.: US 2025/0312722 A1
(43) Pub. Date: Oct. 9, 2025

(54) Scented Air Filter Device and Method of Use

(71) Applicant: Yizhak Cohen, North Hollywood, CA (US)

(72) Inventor: Yizhak Cohen, North Hollywood, CA (US)

(21) Appl. No.: 19/170,795

(22) Filed: Apr. 4, 2025

Related U.S. Application Data
(60) Provisional application No. 63/574,491, filed on Apr. 4, 2024.

(51) Int. Cl. B01D 46/52; B01D 46/00

(52) U.S. Cl. CPC B01D 46/521; B01D 46/0005; B01D 46/0038; B01D 2201/12; B01D 2239/045; B01D 2257/91; B01D 2279/50; B01D 2279/65

(57) ABSTRACT

The present invention is a multifunctional scented air filter designed for use in residential and commercial settings, as well as vehicles. The air filter functions to filter air passing therethrough while providing fragrance. The filter features a support frame and a filter media. The filter media has a plurality of filtering pleats for filtering airborne contaminants and a plurality of scented gel lines having infused fragrance for permeating fragrance when air passes through them. The scented gel lines are positioned along some of the filtering pleats. In some embodiments, the filter device has notches on the support frame for fastening the device in a vent and an anti-microbial layer for providing additional prevention from airborne contaminants. The scented air filter enables clean air to be released into the building or vehicle, while simultaneously infusing it with a fragrance.

### CROSS-REFERENCE TO RELATED APPLICATION

The present application claims priority to, and the benefit of, U.S. Provisional Application No. 63/574,491, which was filed on Apr. 4, 2024, and is incorporated herein by reference in its entirety.

### FIELD OF THE INVENTION

The present invention relates generally to the field of air filters. More specifically, the present invention relates to a novel air filter designed for use in residential and commercial settings, as well as vehicles. The air filter includes a filtering media for filtering out dust, pollen, pathogens, and other airborne particles, while scented gel lines integrated into the filter media release a pleasant aroma as warm or cool air is expelled through the filter. Accordingly, the present disclosure makes specific reference thereto. Nonetheless, it is to be appreciated that aspects of the present invention are also equally applicable to other like applications, devices, and methods of manufacture.

### BACKGROUND

By way of background, for a long time, air filters have been a part of heaters, air conditioners, and other HVAC systems to stop debris and pathogens from entering the living, driving, and/or working spaces through the system. Similar to this, vents are put in place in cars to discharge hot and cold air. Utilizing either type of vent without a filter can be dangerous since they emit a variety of airborne pollutants and contaminants that can lead to allergies and other health problems. Further, standard filters can stop the entry of particles, but they do not release any fragrance into the air, which can be an issue for many individuals who prefer a pleasant scent in their homes and vehicles. Air blowing from vents can include unpleasant odors which is not removed or reduced by standard air filters.

Individuals value and desire clean, fresh air in their homes, vehicles, and other living places/spaces. Individuals frequently use air fresheners to mask undesirable aromas or just to freshen the air in living places/spaces because the air there often smells musty. Yet, presently known products' effects are frequently transient and may be undetected in a matter of minutes. Aerosol air fresheners are not a desired option because they are recognized to be bad for the environment.

Scented candles are also a popular choice since they help cover up the smell of dogs, smoking, and other undesirable scents. But, after a few uses, these candles usually burn out, and buying new ones to replenish burned out candles is expensive. Moreover, candles can emit toxic gases and present a fire risk. Individuals desire a device for providing scented and filtered air inside a room or a space in a building or a vehicle while overcoming the challenges of existing scent providing devices.

Therefore, there exists a long-felt need in the art for an improved air filter that combines the function of a standard air filter with a scent diffuser. There is also a long-felt need in the art for an improved air filter that uses similar technology as a standard filter to prevent debris from passing through the HVAC system, while also releasing a pleasant scent into the air. Additionally, there is a long-felt need in the art for an HVAC air filter whose effects of the scented air filter lasts longer than air fresheners and candles. Moreover, there is a long-felt need in the art for a scented air filter that helps in maintaining a fresh and healthy living environment. Further, there is a long-felt need in the art for an air filter that reduces the use of harmful and short-lived air freshening products for rooms, vehicles, and other enclosed spaces. Finally, there is a long-felt need in the art for an air filter that reduces particulates in the air while ensuring the area smells fresh and fragrant for long periods of time.

The subject matter disclosed and claimed herein, in one embodiment thereof, comprises an improved scented air filter for vents of an HVAC system, a heater, a vehicle, and more. The air filter reduces particulates in the air while ensuring the area smells fresh and fragrant for long periods of time. The scented air filter includes a support frame designed to fit in a vent and has a continuous cavity along the inner surface thereof to support and receive an air filter media, the filter media configured to filter air flowing therethrough. A plurality of scented gel lines can be integrated in the center of the filter media along the filter pleats, wherein the scented gel lines are configured to release a fragrance when air passes through and over them, thereby releasing a pleasant fragrance in a room or space.

In this manner, the scented air filter for an HVAC system, a heater vent, a vehicle vent, and more of the present invention accomplishes all of the forgoing objectives and provides users with an improved air filter that releases a pleasant scent as warm or cool air passes therethrough and therearound. The scented gel lines permeate a fragrance disposed thereon without obstructing airflow passing therethrough to create or emit an aroma. Without the need for the user to use candles, air fresheners, aerosol spray, or similar products, the air filter provides filtered air with a pleasant aroma for extended periods of time.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an improved scented air filter for vents of HVAC systems, heaters, vehicles, and more. The scented air filter further comprising a support frame designed to fit in a vent and configured to have a continuous cavity along the inner surface thereof, the cavity is configured to support and receive an air filter media, the filter media configured to filter air flowing through the vent by entrapping dirt, pollen, and other contaminants, the filter media is fibrous and having a plurality of filtering pleats configured to pass air therethrough while entrapping contaminants, a plurality of scented gel lines positioned in the center of the filter media, wherein each scented gel line containing gel soaked in a fragrant liquid and positioned along a filtering pleat, the scented gel lines are configured to release fragrance when air passes through and around them, thereby releasing a pleasant fragrance in a room or space. The scented gel lines function as filtering pleats and do not obstruct the flow of air, while the fragrant liquid can be of any desired fragrance.

In yet another embodiment, a scented air filter that reduces particulates in the air while ensuring the area smells fresh and fragrant for long periods of time is disclosed. The scented air filter includes a support frame designed to fit in a vent and configured to support and receive a filter media, the support frame having a grid to protect the filter media from damage, the filter media configured to filter air by entrapping dirt, pollen, and other contaminants, and having a plurality of filtering pleats configured to pass air therethrough while entrapping contaminants, a plurality of scented gel lines positioned in the center of the filter media, wherein each scented gel line containing gel soaked in a fragrant liquid, and configured to release fragrance when air passes through and around the gel lines, wherein the scented gel lines and filtering pleats provide a filtering efficiency of up to 95% and the scented gel lines provide fragrance dispersion in the range from about 0.2 mg/m³ to about 0.8 mg/m³.

In yet another embodiment, the scented air filter has a pair of notches to fit the support frame to a vent.

In yet another embodiment, the scented gel lines are silica-based gel or water-based gel and further contains natural fragrance which lasts up to 90 days.

In yet another embodiment, a method for freshening the air flowing through a vent of a heating, ventilation, and/or air conditioning (HVAC) system or of a vehicle is described. The method comprising providing a scented air filter comprising a support frame configured to support and receive a filter media having a plurality of filtering pleats and a plurality of scented gel lines positioned in the center of the filter media across opposing pairs of edges, wherein each scented gel line contains gel soaked in a fragrant liquid and the scented gel lines do not contain volatile organic compounds (VOCs), inserting the scented air filter into the vent of the HVAC system such that air flowing through the vent passes through the filter media and the scented gel lines, enabling the scented gel lines to permeate a fragrance over time when air passes through and around them, wherein the fragrance lasts up to 90 days, filtering out dust, pollen, pathogens, and other airborne particles from the air passing through the filter media, and replacing the scented air filter after up to 90 days of use.

In yet another embodiment, the scented air filter of the present invention is easily and efficiently manufactured, marketed, and available to consumers in a cost-effective manner and is easily used by users for clean and pleasant air in a building, home, vehicle, and the like.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a scented air filter of the present invention in accordance with the disclosed architecture;

FIG. 2 illustrates a perspective view of the scented air filter of FIG. 1 of the present invention being inserted into an HVAC vent for use in accordance with the disclosed architecture;

FIG. 3 illustrates an enlarged view of the scented gel lines used in the fragrant air filter of the present invention in accordance with the disclosed architecture;

FIG. 4 illustrates a perspective view showing the air filter of the present invention installed in a vehicle's vent for providing clean and pleasant air in accordance with the disclosed architecture;

FIG. 5 illustrates a cross sectional view of one potential embodiment of the aroma releasing air filter of the present invention in accordance with the disclosed architecture;

FIG. 6 illustrates yet another potential embodiment of the aroma releasing air filter of the present invention in accordance with the disclosed architecture; and

FIG. 7 illustrates a flow diagram depicting a process of using the scented air filter of different embodiments of the present invention for filtering air while providing a fragrance in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved air filter that combines the function of a standard air filter with a scent diffuser. There is also a long-felt need in the art for an improved air filter that uses similar technology as a standard filter to prevent debris from passing through the HVAC system, while also releasing a pleasant scent into the air. Additionally, there is a long-felt need in the art for an HVAC air filter whose effects of the scented air filter last longer than air fresheners and candles. Moreover, there is a long-felt need in the art for a scented air filter that helps in maintaining a fresh and healthy living environment. Further, there is a long-felt need in the art for an air filter that reduces the use of harmful and short-lived air freshening products for rooms, vehicles, and other enclosed spaces. Finally, there is a long-felt need in the art for an air filter that reduces particulates in the air while ensuring the area smells fresh and fragrant for long periods of time.

The present invention, in one exemplary embodiment, is a method for freshening the air flowing through a vent of a heating, ventilation, and/or air conditioning (HVAC) system or through a vent of a vehicle. The method providing a scented air filter comprising a support frame configured to support and receive a filter media having a plurality of filtering pleats and a plurality of scented gel lines positioned in the center of the filter media across opposing pairs of edges, wherein each scented gel line contains gel soaked in a fragrant liquid and the scented gel lines do not contain volatile organic compounds (VOCs), inserting the scented air filter into the vent of the HVAC system such that air flowing through the vent passes through the filter media and the scented gel lines, enabling the scented gel lines to permeate or emit a fragrance over time when air passes through and around the gel lines, wherein the fragrance lasts up to 90 days, filtering out dust, pollen, pathogens, and other airborne particles from the air passing through the filter media.

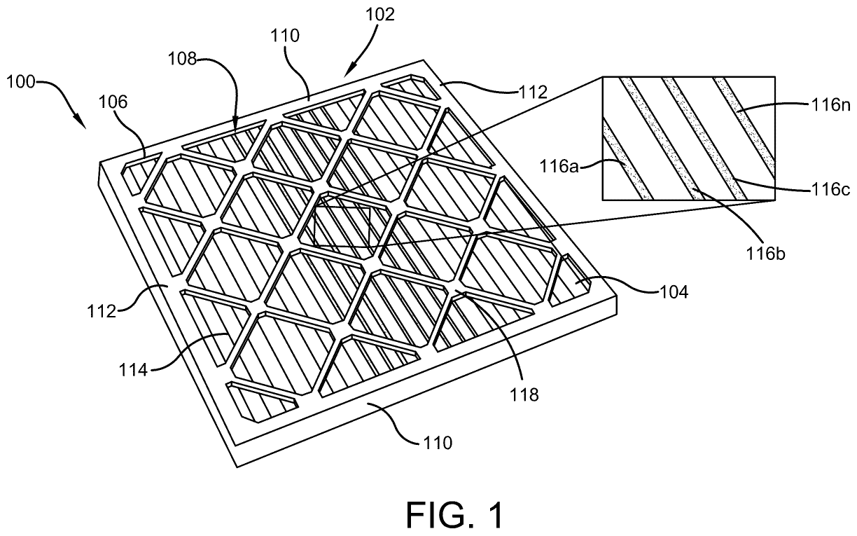

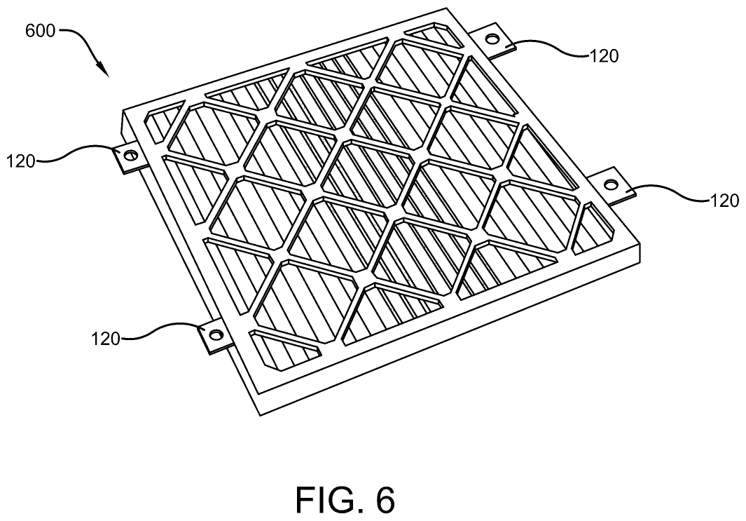

Referring initially to the drawings, FIG. 1 illustrates a perspective view of one potential embodiment of a scented air filter of the present invention in accordance with the disclosed architecture. The scented air filter 100 of the present invention is designed as an improved air filter configured to release a pleasant scent as warm or cool air passes therethrough. More specifically, the scented air filter 100 has a support frame 102 configured to support and receive a filter media 104. The support frame 102 is designed to fit in a vent of any residential, business area, or vehicle space, and can come in different shapes and sizes. Further, the support frame 102 orients the filter media 104 enabling air passing through the filter media 104 to filter out dust, pollen, pathogens, and other airborne particles. A continuous cavity 106 is disposed along the inner surface 108 of the opposing pairs 110, 112 of edges of the frame 102 for receiving and securing the filter media 104. In some embodiments, the support frame 102 has a plurality of notches 120 as illustrated in FIG. 6 for securing the frame 102 to a vent of HVAC system or other types of vents. The notches 120 function as fasteners for the frame 102 and helps in easy and secure placement of the air filter device 100.

The filter media 104 is designed to filter air passing therethrough by entrapping dirt, pollens, and other contaminates. Preferably, the filter media 104 is designed to fit in the support frame 102 and can be made of any suitable woven or non-woven material including, but not limited to, paper, fiberglass, cotton, polyester, pleated paper, and more. The filter media 104 has a plurality of filtering pleats 114 configured to pass air therethrough while entrapping contaminants. The filtering pleats 114 extend between a first pair of opposing edges 110 and across a second pair of opposing edges 112. A plurality of scented gel lines 116a-n are positioned in the center of the filter media 104 across the opposing pair of edges 110. Each scented gel line contains gel soaked in a fragrant liquid and the fragrance lasts up to 90 days wherein the scented gel lines 116a-n permeate fragrance over time when air passed through them. The fragrant liquid can be of any desired fragrance including, but not limited to, lavender, orange, lemon, rose, and more. The scented gel lines 116a-n can be silica-based gel or water-based gel and further the fragrant material can be transparent or opaque.

The scented gel lines 116a-n also function as filtering pleats that do not obstruct flow of air passing therethrough. In one exemplary embodiment, the scented gel lines 116a-n do not contain volatile organic compounds (VOCs) such as xylene, ketones, and aldehydes. The filtering pleats 114 together with the scented gel lines 116a-n provide a filtering efficiency of up to 95% and the scented gel lines 116a-n provide fragrance dispersion in the range from about 0.2 mg/m³ to about 0.8 mg/m³. In some embodiments, the color of the scented gel lines 116a-n can be different from the filtering pleats 114 and alternatively, the color can be same.

The filter media 104 can have an anti-microbial layer for further protection from microbes. The support frame grid 118 is disposed and connected to the support frame 102 and is configured to protect the filter media 104 from physical damage. The air filter 100 is replaceable and in a preferred embodiment, can last up to 90 days. The pleats having scented gels in the preferred embodiment ranges from about 25% to about 35% of the total filtering pleats in the filter media. In other embodiments, 50% of the pleats can have scented gel lines for providing stronger fragrance.

It should be appreciated that the air filter 100 automatically diffuses a pleasant fragrance when cold or warm air blows through the filter 100, thereby eliminating requirements of a user to use candles, aerosols, air fresheners, and more for filtering/freshening air in an enclosed space.

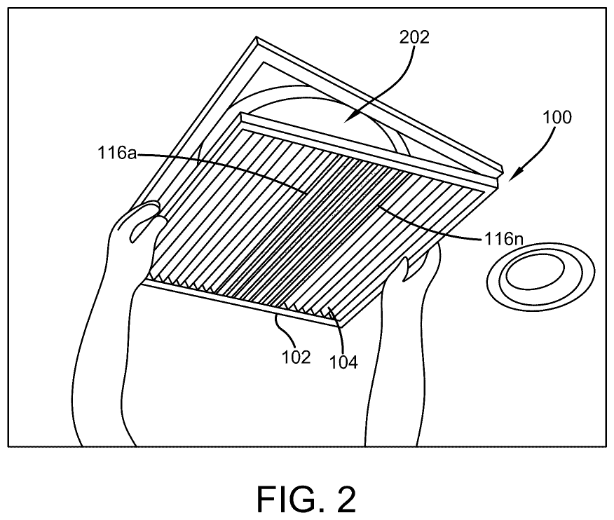

FIG. 2 illustrates a perspective view of the scented air filter 100 of FIG. 1 of the present invention being inserted into an HVAC vent for use in accordance with the disclosed architecture. The air filter 100 is inserted and accommodated inside a vent 202 by holding the frame support 102 such that the frame 102 fits in the vent 202, thereby enabling air to pass through the vent 202 and to pass through the filter media 104. Air passing through the scented gel lines 116a-n permeates or emits the scent and a pleasant aroma then fills the room in which the vent 202 is positioned. Referring to FIG. 6, the notches 120 can also be used for securing the filter device 100 in the vent 202.

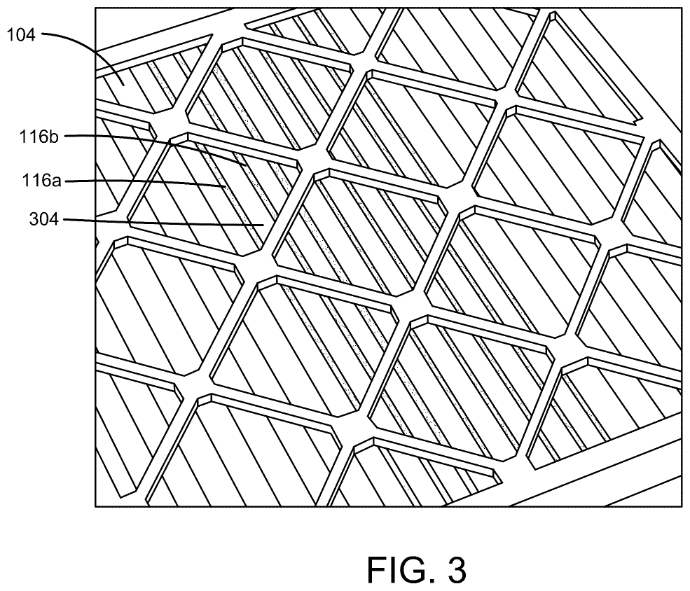

FIG. 3 illustrates an enlarged view of the scented gel lines used in the fragrant air filter of the present invention in accordance with the disclosed architecture. Each scented gel line is adhered to a corresponding filtering pleat using an adhesive or any fastening means known in the art. The scented gel lines 116a-n are elongated and have a length substantially equal to a length of the filtering pleats 114. Further there is a gap or space disposed between adjacent scented gel lines, for example filter media 304 between adjacent gel lines 116a and 116b, enabling air to pass through and therebetween such that airflow is not obstructed. Similar gaps are disposed between each pair of scented line and subsequent pleat.

The scented gel lines 116a-n can be of any fragrance and extend outwards for about 0.25″ from the corresponding filtering pleat. The air passing through the filter media 104 and touching any of the scented gel lines 116a-n creates a pleasant aroma. The fibrous filter media 104 helps in prohibiting airborne pathogens, dirt, pollutants, and more from passing through the air filter 100.

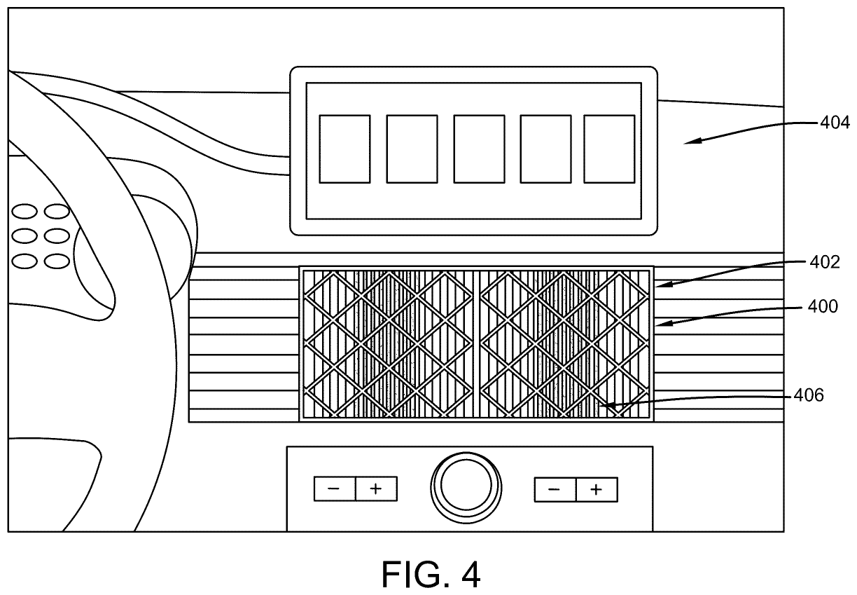

FIG. 4 illustrates a perspective view showing the air filter of the present invention installed in a vehicle's vent for providing a clean and pleasant air filtration in accordance with the disclosed architecture. The filter 400 is designed and dimensioned to fit an air AC vent 402 of a vehicle 404, thereby enabling air from the vent 402 to pass through while entrapping airborne pathogens and pollutants. Further, the scented gel lines 406 of the filter 400 helps in providing pleasant air inside the vehicle in a similar manner as described in other embodiments of the present invention. The air filter 400 can be designed to fit vents of different sizes without affecting utility of the filter 400. The filter 400 may be available in a variety of colors and scents. The frame of the scented air filter 400 may be made in various colors if desired to meet aesthetics of the vehicle 404.

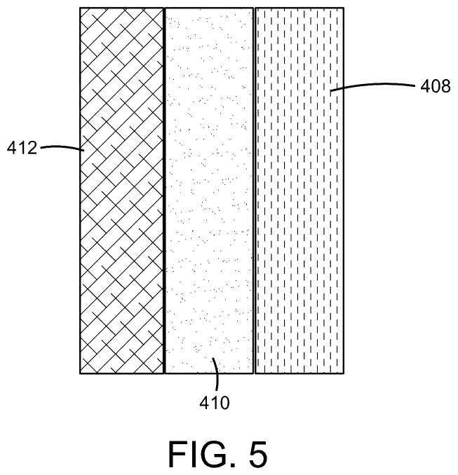

FIG. 5 illustrates a cross sectional view of one potential embodiment of the aroma releasing air filter of the present invention in accordance with the disclosed architecture. The aroma releasing filter 400 has a filter media 408 including a plurality of filtering pleats for passing air therethrough. The filter media 408 also has a plurality of scented gel lines for providing aroma to the passing air. Further, an additional anti-microbial layer 410 is positioned behind the filter media 408 for additional protection from pathogens. The anti-microbial layer 410 is thin and has a thickness of up to 1 cm. An additional thin and permeable filtering sheet 412 is positioned behind the anti-microbial layer 410 for providing a passage to the air while prohibiting microbes and small germs from passing therethrough. The layers 410, 412 help in effective protection from germs while the scented gel lines help in creating a pleasant aroma in a room.

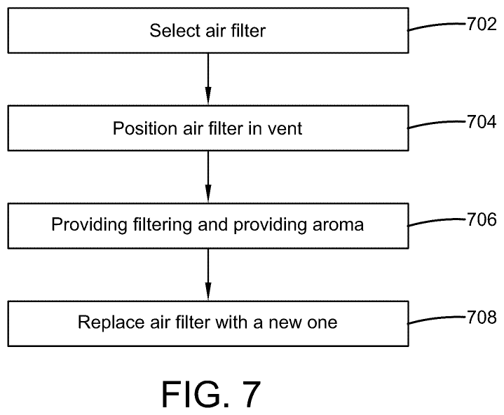

FIG. 7 illustrates a flow diagram depicting a process of using the scented air filter of different embodiments of the present invention for filtering air while providing fragrance in accordance with the disclosed architecture. Initially, an air filter of appropriate dimension is selected by a user to fit in a vent (Step 702). Then, the selected air filter is positioned in the vent such that the air passing through the vent passes through filter media of the air filter device (Step 704). Thereafter, filtering of air is performed by the filter media while aroma is provided by scented gel lines of the filter device (Step 706). Finally, after a period, when the aroma of the scented gel lines is exhausted, the filter device is removed and replaced with a new filter device (Step 708).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “aroma releasing air filter”, “scented air filter”, “fragrant air filter”, “air filter device”, and “filter device” are interchangeable and refer to the aroma releasing air filter device 100, 400, 600 of the present invention.

Notwithstanding the forgoing, the aroma releasing air filter device 100, 400, 600 of the present invention can be of any suitable size and configuration as is known in the art without affecting the overall concept of the invention, provided that it accomplishes the above-stated objectives. One of ordinary skill in the art will appreciate that the aroma releasing air filter device 100, 400, 600 as shown in the FIGS. are for illustrative purposes only, and that many other sizes and shapes of the aroma releasing air filter device 100, 400, 600 are well within the scope of the present disclosure. Although the dimensions of the aroma releasing air filter device 100, 400, 600 are important design parameters for user convenience, the aroma releasing air filter device 100, 400, 600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A scented air filter comprising:
a support frame;
a continuous cavity; and
a filter media;
wherein said support frame having a mount to fit to a vent;
wherein said filter media entraps contaminants;
wherein said support frame orients said filter media for enabling air to pass therethrough;
wherein said continuous cavity disposed along an inner surface of opposing pairs of edges of said support frame for receiving said filter media;
wherein said support frame having a plurality of notches for securing said support frame to the vent;
wherein said filter media having a plurality of filtering pleats configured to pass air therethrough while entrapping the contaminants;
wherein said filtering pleats extend between a first pair of opposing edges and across a second pair of opposing edges;
a plurality of scented gel lines positioned in the center of said filter media across at least said first pair of opposing edges; and
further wherein said plurality of scented gel lines each include a scented gel soaked in a fragrant liquid.

2. The scented air filter of claim 1, wherein said filter media including a material selected from a group consisting of a paper, a fiberglass, a cotton, a polyester, and a pleated paper.

3. The scented air filter of claim 2, wherein the contaminants selected from a group consisting of a dust, a pollen, a pathogen, and an airborne particle.

4. The scented air filter of claim 3, wherein said fragrant liquid selected from a group consisting of a lavender, an orange, a lemon, and a rose.

5. The scented air filter of claim 3, wherein said plurality of scented gel lines include a material selected from a group consisting of a silica-based gel and a water-based gel.

6. The scented air filter of claim 5, wherein said plurality of scented gel lines are transparent.

7. The scented air filter of claim 5, wherein said plurality of scented gel lines are opaque.

8. The scented air filter of claim 5, wherein said plurality of scented gel lines having a fragrance dispersion in the range from 0.2 mg/m³ to 0.8 mg/m³.

9. The scented air filter of claim 8, wherein said filter media having an anti-microbial layer.

10. The scented air filter of claim 9, wherein said support frame having a frame grid connected to said support frame to protect said filter media.

11. The scented air filter of claim 10, wherein said filtering pleats containing said plurality of scented gel lines in the range of 25% to 35%.

12. The scented air filter of claim 10, wherein said filtering pleats containing said plurality of scented gel lines up to 50% of a total number of said filtering pleats.

13. The scented air filter of claim 10, wherein each said scented gel line adhesively adhered to an individual corresponding said filtering pleat.

14. The scented air filter of claim 10, wherein each said scented gel line having a length substantially equal to a length of said filtering pleat.

15. The scented air filter of claim 11, wherein adjacent said plurality of scented gel lines having a space of said filter media therebetween.

16. The scented air filter of claim 11, wherein the vent is a vehicle vent and wherein said scented air filter covers the vehicle vent.

17. A scented air filter comprising:
a support frame;
a continuous cavity; and
a filter media confined within the continuous cavity;
wherein said support frame having a mount to fit to a vent;
wherein said filter media entraps contaminants;
wherein said support frame orients said filter media for enabling air to pass therethrough;
wherein said continuous cavity disposed along an inner surface of opposing pairs of edges of said support frame for receiving said filter media;
wherein said support frame having a plurality of notches for securing said support frame to the vent;
wherein said filter media having a plurality of filtering pleats configured to pass air therethrough while entrapping the contaminants;
wherein said filtering pleats extend between a first pair of opposing edges and across a second pair of opposing edges;
a plurality of scented gel lines positioned in the center of said filter media across at least said first pair of opposing edges;
wherein said plurality of scented gel lines each include a scented gel soaked in a fragrant liquid; and
further wherein said scented air filter is a multi-layered filter having said filter media layer, an anti-microbial layer, and a filtering sheet layer.

18. A scented air filter comprising:
a support frame;
a continuous cavity; and
a filter media confined in the continuous cavity;
wherein said support frame having a mount to fit to a vent;
wherein said filter media entraps contaminants;
wherein said support frame orients said filter media for enabling air to pass therethrough;
wherein said continuous cavity disposed along an inner surface of opposing pairs of edges of said support frame for receiving said filter media;
wherein said filter media having a plurality of filtering pleats configured to pass air therethrough while entrapping the contaminants;
wherein said filtering pleats extend between a first pair of opposing edges and across a second pair of opposing edges;
a plurality of scented gel lines positioned in the center of said filter media across at least said first pair of opposing edges;
wherein said plurality of scented gel lines each include a scented gel soaked in a fragrant liquid; and
further wherein said plurality of scented gel lines having a fragrance dispersion in the range from 0.2 mg/m³ to 0.8 mg/m³.

19. The scented air filter of claim 18, wherein said filter media having an anti-microbial layer.

20. The scented air filter of claim 19, wherein said filtering pleats containing said plurality of scented gel lines in the range of 25% to 35%.
